(19) United States
(12) Patent Application Publication
(10) Pub. No.: US 2003/0030172 A1
(43) Pub. Date: Feb. 13, 2003

(54) Formed decorative film

(76) Inventors: Gabrie Hoogland, Breda (NL); Christianus Maas, Rilland (NL); Michael M. Laurin, Pittsfield, MA (US); Robert Puyenbroek, Bergen op Zoom (NL)

Correspondence Address: Robert E. Walter, GE Plastics, One Plastics Avenue, Pittsfield, MA, 01201, US

(21) Appl. No.: 09/882,994

(22) Filed: Jun. 15, 2001

(51) Int. Cl. B29C 45/14

(52) U.S. Cl. 264/161; 264/265

(57) ABSTRACT

In a method of molding, a decorative substantially transparent cycloaliphatic polyester resin substrate is formed into a three-dimensional shape, placed into a mold, and a resin is injection molded into the mold cavity space behind the formed substrate.

### FIELD OF INVENTION

This invention relates to decorative films used in molding processes.

### BACKGROUND OF THE INVENTION

In a typical in-mold decorating process (IMD), a printed substrate is formed into a three-dimensional shape and placed into a mold. Molten resin is then injected into the mold cavity space behind the formed substrate to form a single molded part.

IMD may involve two types of film processes. According to one process, the film is a permanent fixture of the finished good. In this case, the film may act as the aesthetic effect carrier, or as a protective layer for the base resin, aesthetic effect, or both. Good adhesion is desired between the film, such as a polycarbonate type film, and the base resin.

According to another process, the film may be a temporary carrier for the aesthetic effect. In this case a base resin may be back-molded to the IMD film. The film is subsequently peeled off of the base resin, transferring or leaving an aesthetic material or design on the substrate resin. Good adhesion is not desired between the film, which may be a poly (ethylene terephthalate) type film and the substrate resin.

For both types of in-mold decorating (IMD) applications, ink washout of the IMD film is an inherent problem. When an ink (or other aesthetic enhancement) bearing or containing film is back-molded by a base resin, the aesthetic ink or effect material is often sandwiched between the IMD film and the substrate resin. The resulting shear from the back-molding injection of the substrate resin material against the IMD film, coupled with the heat of the molten substrate resin may cause the ink (or aesthetic bearing material) to detach itself from the IMD film. As a result, an area of decreased ink concentration, or “washout” may form. This washout is caused by several processing factors of the substrate resin, including processing temperature and injection shear.

Other challenges during the IMD process are foil breakage or wrinkling which may be a result of the high pressures and temperatures needed to back mold.

A resin used as an IMD base material is a blend of polycarbonate (PC) with ABS (acrylonitrile-butadiene-styrene), such as a CYCOLY®) resin produced by GE Plastics. PC/ABS blends have typically have enhanced shear thinning which enables the molder to fill the mold at lower injection rates and temperatures.

U.S. Pat. No. 3,654,062 to Loew describes a molded decorative plaque having a laminated facing sheet, which has the configuration of the mold. Heated plastic is injection molded behind the sheet to form the plaque. U.S. Pat. No. 6,117,384 to Laurin et al. describes a process where colors are decorated into a single film, which is then incorporated with a molten resin injected behind the film to produce a permanently bonded three-dimensional piece. U.S. Pat. No. 4,391,954 to Scott describes a thermoplastic molding composition comprising an aromatic carbonate polymer and a polyester derived from a cyclohexanedimethanol. U.S. Pat. No. 4,125,572 to Scott describes a thermoplastic molding composition comprising an aromatic carbonate polymer and a polyester derived from an aliphatic or cycloahiphatic diol. U.S. Pat. No. 4,662,966 to Nissha Printing Co. Ltd. describes a transfer-printing machine where designs of a diffusible dye on a transfer sheet are transferred to heated articles.

For the film or substrate material, it is often desired to have a high clarity material with improved chemical resistance and with low temperature impact. The chemical resistance of many transparent and translucent amorphous materials is not sufficient against chemicals like oleic acid or sun tanning lotions, which are considered to be important chemicals in qualifying new materials for molding applications in for use in telecom and electronics businesses.

### SUMMARY OF INVENTION

In a method of molding, a decorative substrate is formed into a three-dimensional shape, placed into a mold, and a resin is injection molded into the mold cavity space behind the formed substrate. The decorative substrate comprises a substantially transparent cycloaliphatic polyester resin.

According to one process, during the back molding, ink may be transferred from a film to the transparent base resin. Removal of the film, dye or ink is transferred to the base material resulting in a decorated front cover. An example of transfer printing is the Nissha process. See U.S. Pat. No. 4,662,966 to Sumi et al. According to the process set forth, articles to be transferred-printed are heated such as by infrared radiation. A transfer sheet having an image or aesthetic effect formed thereon with a diffusible dye is pressed against the surface of the articles so that the aesthetic effect is transferred to the surfaces of the heated articles. The transfer sheet is then removed. The transfer sheet, which carries the diffusible dye, desirably comprises a cycloaliphatic polyester resin.

For some applications, the film of substrate material may be a permanent aesthetic part of the finished product. The transparent base material is molded to create a transparent window. Data may be transferred to/from the electronic product to its server by IR through the transparent window which is integrated into the structural resin of the product. Holes in the film expose the transparent injected molded base resin for either data transfer or aesthetic purposes.

Cycloaliphatic polyester with or without additional resins may be utilized as a decorated (IMD) film. Transparent blends of polycarbonate (PC) and the cycloaliphatic polyester, preferably poly(cyclohexane dimethanol cyclohexane dicarboxylate) (PCCD) possess lower processing temperatures and improved flow characteristics over standard PC materials. These blends offer enhanced chemical resistance and ductility to that of most transparent resin materials. The complete miscibility of this system allows the properties of the resulting blend to be dialed in, via blend ratio, while still maintaining transparency.

Two types of cycloaliphatic polyesters may desirable be used with BPA-based polycarbonate to give the compositions and articles of this invention. The most preferred polyester molecules are derived from cycloaliphatic diol and cycloaliphatic diacid compounds, specifically polycyclohexane dimethanol cyclohexyl dicarboxylate (PCCD). The polyester having only one cyclic unit may also be useful.

In addition, PCCD and PC can be blended with certain impact modifiers (IM) at such ratios as to match the refractive index (RI) of the impact modifier to that of the PC/PCCD blend and therefore still retain transparency. In addition to the characteristics of PC/PCCD resins, these PC/PCCD/IM blends possess improved low temperature ductility which can be a key requirements for IMD applications, for example, cellphone covers.

The substrate may be in the form of a film or sheet and may be multi-layered films having one or more layers comprising the cycloaliphatic material. The decorative portion may be sandwiched between layers for protective purposes. The film desirable has favorable properties of formability, low birefringence, chemical, UV radiation resistance, and optical transparency. These laminated films are suited for exterior automotive insert mold decoration (IMD) applications. According to an IMD process, a formed, and decorated film is placed in a mold and the thermoplastic melt, which forms the base layer, is injection molded to the exposed surface of the film

### DETAILED DESCRIPTION OF THE INVENTION

The process for creating the decorative or aesthetic effect comprises forming a resin comprising a substantially transparent cycloaliphatic polyester into a desired shape and molding a base material adjacent a decorative or aesthetic material substrate or film wherein the decorative or aesthetic effect is imparted to the formed article.

According to one embodiment, molded articles are prepared by the steps of:

1. providing a decorative substantially transparent resin comprising a blend of cycloaliphatic polyester resin and a polycarbonate resin having one or more colors on a surface, for example by screen printing or by a transfer dye;

2. conforming the decorative substrate to a mold configuration such as by forming and trimming a printed substrate into a three-dimensional shape and fitting the printed substrate into a mold having a surface which matches the there-dimensional shape of the substrate: and

3. injecting a resin material into the mold cavity behind the printed substrate to i) produce a one-piece, permanently bonded three-dimensional product or ii) transfer a pattern or aesthetic effect from the cycloaliphatic polyester resin and removing the printed substrate and imparting the aesthetic effect to the formed base material.

In cases where the polycarbonate has a high Tg and is difficult to process the cycloaliphatic polyester acts to lower the PC Tg. A blend with a cycloaliphatic polyester reduces Tg making melt processing easier while the blend has excellent optical properties overall. The most preferred materials will be blends where the polyester has both cycloaliphatic diacid and cycloaliphatic diol components specifically polycyclohexane dimethanol cyclohexyl dicarboxylate (PCCD). The preferred polycarbonate will be composed of units of BPA, SBI bis phenol, aryl substituted bisphenols, cycloaliphatic bisphenols and mixtures thereof. It is contemplated that acidic phosphorus based stabilizers are useful to retard melt reaction of the cycloaliphatic polyester and polycarbonate resin and improve color.

According to one embodiment, the substrate, which may be in the form of a sheet or film, may consists essentially of a cycloaliphatic resin.

Optionally, depending on the properties desired, polycarbonate may be present in an amount up to about 80 percent by weight. The amount of polycarbonate may vary over this range with lesser amounts of polycarbonate resulting in a blend having lower forming temperatures. The amount of polycarbonate is preferably less than about 60 percent and for lower forming temperatures less than about 50 percent and even less than about 40 percent. Depending on the application, the ratio of cycloaliphatic polyester to polycarbonate may be in the range of 20:80 to 70:30 by weight. Other useful ranges include 40:60 to 5:95 by weight. Blends from 50:50 to 30:70 are also desirable. Less than 70 weight percent polycarbonate is desirable for a lower heat deflection temperature resulting in improved performance as compared to polycarbonate alone.

The substrate is desirable in the form of a sheet or film. Thickness is typically less than about 12 mm. Preferred thickness is from about 100 to about 1000 microns for certain applications. Another preferred range is from about 125 to about 750 microns.

The presence of the cycloaliphatic polyester results in enhanced chemical resistance and enhanced UV resistance as compared to a base polymeric consisting entirely of polycarbonate. The resulting cycloaliphatic resin or polycarbonate blend therewith desirable has a glass transition temperature of from about 90 to 150° C. and a transmittance of greater than or equal to 75%. Forming temperatures of the resulting resin are preferable less than 190 degrees Centigrade, preferably less than 180 degrees Centigrade, and for certain applications less than about 170 degrees Centigrade. Desirable impact modifiers have properties which do not do not effect the desirable transparent properties and have a refractive index (RI) between 1.51 and 1.58%. Other desirable properties include a chemical resistance of the cycloaliphatic polyester and polycarbonate resin between about one and about 4 percent with Critical Stain as measured with Bergen Jig versus Coppertone, oleic acid and xylene. Preferably the Melt Volume Rate is 300 degrees Centigrade/1.2 kg between 35 and 60 ml/10 min., with a Flexural Modulus between 2200 and 1400 Mpa, and an Heat Deflection Temperature 1.82 Mpa between 115 and 70 degrees Centigrade. Injection molding of the cycloaliphatic polycarbonate blend is preferably performed at a temperature from about 230 to about 300 degrees Centigrade. Due to its lower viscosity at lower melt temperatures as compared to polycarbonate, the PCCD/PC blend is able to backfill the IMD part at a lower injection temperature and pressure then polycarbonate material. Preferably, the polycarbonate is BPA-PC and the cycloaliphatic polyester is PCCD.

The cycloaliphatic polyester resin comprises a polyester having repeating units of the formula I:

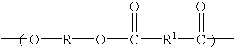

where at least one R or R1 is a cycloalkyl containing radical.

The polyester is a condensation product where R is the residue of an aryl, alkane or cycloalkane containing diol having 6 to 20 carbon atoms or chemical equivalent thereof, and R1 is the decarboxylated residue derived from an aryl, aliphatic or cycloalkane containing diacid of 6 to 20 carbon atoms or chemical equivalent thereof with the proviso that at least one R or R1 is cycloaliphatic. Preferred polyesters of the invention will have both R and R1 cycloaliphatic.

The present cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic diols but must contain at least 50 mole % of cyclic diacid and/or cyclic diol components, the remainder, if any, being linear aliphatic diacids and/or diols. The cyclic components are necessary to impart good rigidity to the polyester and to allow the formation of transparent blends due to favorable interaction with the polycarbonate resin.

The polyester resins are typically obtained through the condensation or ester interchange polymerization of the diol or diol equivalent component with the diacid or diacid chemical equivalent component.

R and R1 are preferably cycloalkyl radicals independently selected from the following formula:

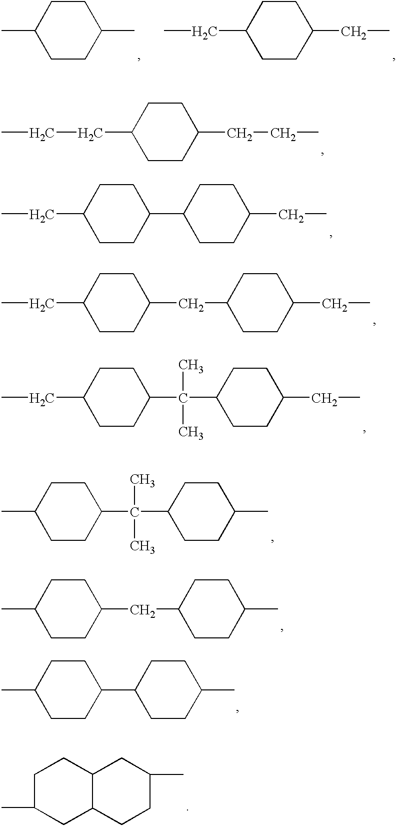

The preferred cycloaliphatic radical R1 is derived from the 1,4-cyclohexyl diacids and most preferably greater than 70 mole % thereof in the form of the trans isomer. The preferred cycloaliphatic radical R is derived from the 1,4-cyclohexyl primary diols such as 1,4-cyclohexyl dimethanol, most preferably more than 70 mole % thereof in the form of the trans isomer.

Other diols useful in the preparation of the polyester resins of the present invention are straight chain, branched, or cycloaliphatic alkane diols and may contain from 2 to 16 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; 2,2,4,4-tetramethyl-1,3-cyclobutanediol (TMCBD), triethylene glycol; 1,10-decane diol; and mixtures of any of the foregoing. Preferably a cycloaliphatic diol or chemical equivalent thereof and particularly 1,4-cyclohexane dimethanol or its chemical equivalents are used as the diol component.

Chemical equivalents to the diols include esters, such as dialkylesters, diaryl esters and the like.

The diacids useful in the preparation of the aliphatic polyester resins of the present invention preferably are cycloaliphatic diacids. This is meant to include carboxylic acids having two carboxyl groups each of which is attached to a saturated carbon. Preferred diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or chemical equivalent. Linear dicarboxylic acids like adipic acid, azelaic acid, dicarboxyl dodecanoic acid and succinic acid may also be useful.

Cyclohexane dicarboxylic acids and their chemical equivalents can be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. See, Friefelder et al., Journal of Organic Chemistry, 31, 3438 (1966); U.S. Pat. Nos. 2,675,390 and 4,754,064. They may also be prepared by the use of an inert liquid medium in which a phthalic acid is at least partially soluble under reaction conditions and with a catalyst of palladium or ruthenium on carbon or silica. See, U.S. Pat. Nos. 2,888,484 and 3,444,237.

Typically, in the hydrogenation, two isomers are obtained in which the carboxylic acid groups are in cis- or trans-positions. The cis- and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well.

When the mixture of isomers or more than one diacid or diol is used, a copolyester or a mixture of two polyesters may be used as the present cycloaliphatic polyester resin.

Chemical equivalents of these diacids include esters, alkyl esters, e.g., dialkyl esters, diaryl esters, anhydrides, salts, acid chlorides, acid bromides, and the like. The preferred chemical equivalents comprise the dialkyl esters of the cycloaliphatic diacids, and the most favored chemical equivalent comprises the dimethyl ester of the acid, particularly dimethyl-1,4-cyclohexane-dicarboxylate.

A preferred cycloaliphatic polyester is poly(cyclohexane-1,4-dimethylene cyclohexane-1,4-dicarboxylate) also referred to as poly(1,4-cyclohexane-dimethanol-1,4-dicarboxylate) (PCCD) which has recurring units of formula II:

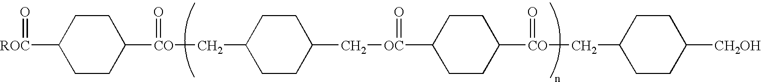

With reference to the previously set forth general formula, for PCCD, R is derived from 1,4 cyclohexane dimethanol; and R1 is a cyclohexane ring derived from cyclohexanedicarboxylate or a chemical equivalent thereof. The favored PCCD has a cis/ trans formula.

The polyester polymerization reaction is generally run in the melt in the presence of a suitable catalyst such as a tetrakis (2-ethyl hexyl) titanate, in a suitable amount, typically about 50 to 200 ppm of titanium based upon the final product.

The preferred aliphatic polyesters used in the present transparent molding compositions have a glass transition temperature (Tg) which is above 50° C., more preferably above 80° C. and most preferably above about 100° C.

Also contemplated herein are the above polyesters with from about 1 to about 50 percent by weight, of units derived from polymeric aliphatic acids and/or polymeric aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

Polycarbonates useful in the invention comprise the divalent residue of dihydric phenols, Ar′, bonded through a carbonate linkage and are preferably represented by the general formula III:

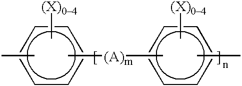

wherein A is a divalent hydrocarbon radical containing from 1 to about 15 carbon atoms or a substituted divalent hydrocarbon radical containing from 1 to about 15 carbon atoms; each X is independently selected from the group consisting of hydrogen, halogen, and a monovalent hydrocarbon radical such as an alkyl group of from 1 to about 8 carbon atoms, an aryl group of from 6 to about 18 carbon atoms, an arylalkyl group of from 7 to about 14 carbon atoms, an alkoxy group of from 1 to about 8 carbon atoms; and m is 0 or 1 and n is an integer of from 0 to about 5. Ar′ may be a single aromatic ring like hydroquinone or resorcinol, or a multiple aromatic ring like biphenol or bisphenol A.

The dihydric phenols employed are known, and the reactive groups are thought to be the phenolic hydroxyl groups. Typical of some of the dihydric phenols employed are bis-phenols such as bis(4-hydroxyphenyl)methane, 2,2-bis(4-hydroxyphenyl)propane (also known as bisphenol-A), 2,2-bis(4-hydroxy-3,5-dibromo-phenyl)propane; dihydric phenol ethers such as bis(4-hydroxyphenyl)ether, bis(3,5-dichloro-4-hydroxyphenyl)ether; p,p′-dihydroxydiphenyl and 3,3′-dichloro-4,4′-dihydroxydiphenyl; dihydroxyaryl sulfones such as bis(4-hydroxyphenyl)sulfone, bis(3,5-dimethyl-4-hydroxyphenyl)sulfone, dihydroxy benzenes such as resorcinol, hydroquinone, halo- and alkyl-substituted dihydroxybenzenes such as 1,4-dihydroxy-2,5-dichlorobenzene, 1,4-dihydroxy-3-methylbenzene; and dihydroxydiphenyl sulfides and sulfoxides such as bis(4-hydroxyphenyl)sulfide, bis(4-hydroxy-phenyl)sulfoxide and bis(3,5-dibromo4-hydroxyphenyl)sulfoxide. A variety of additional dihydric phenols are available and are disclosed in U. S. Pat. Nos. 2,999,835, 3,028,365 and 3,153,008; all of which are incorporated herein by reference. It is, of course, possible to employ two or more different dihydric phenols or a combination of a dihydric phenol with a glycol.

The carbonate precursors are typically a carbonyl halide, a diarylcarbonate, or a bishaloformate. The carbonyl halides include, for example, carbonyl bromide, carbonyl chloride, and mixtures thereof. The bishaloformates include the bishaloformates of dihydric phenols such as bischloroformates of 2,2-bis(4-hydroxyphenyl)-propane, hydroquinone, and the like, or bishaloformates of glycol, and the like. While all of the above carbonate precursors are useful, carbonyl chloride, also known as phosgene, and diphenyl carbonate are preferred.

The aromatic polycarbonates can be manufactured by processes, which react a dihydric phenol with a carbonate precursor, such as phosgene, a haloformate or carbonate ester in melt or solution. U.S. Pat. No. 4,123,436 describes reaction with phosgene and U.S. Pat. No. 3,153,008 describes a transesterification process.

Preferred polycarbonate will be made of dihydric phenols that result in resins having low birefringence for example dihydric phenols having pendant aryl or cup shaped aryl groups like:

Phenyl-di(4-hydroxyphenyl) ethane (acetophenone bisphenol):

Diphenyl-di(4-hydroxyphenyl) methane (benzophenone bisphenol):

2,2-bis(3-phenyl-4-hydroxyphenyl) propane

2,2-bis-(3,5-diphenyl-4-hydroxyphenyl) propane;

bis-(2-phenyl-3-methyl4-hydroxyphenyl) propane;

2,2′-bis(hydroxyphenyl)fluorene;

1,1-bis(5-phenyl-4-hydroxyphenyl)cyclohexane;

3,3′-diphenyl-4,4′-dihydroxy diphenyl ether;

2,2-bis(4-hydroxyphenyl)-4,4-diphenyl butane;

1,1-bis(4-hydroxyphenyl)-2-phenyl ethane;

2,2-bis(3-methyl-4-hydroxyphenyl)-l-phenyl propane;

6,6′-dihdyroxy-3,3,3′,3′-tetramethyl-1,1′-spiro(bis)indane;

(hereinafter “SBI”), or dihydric phenols derived from Spiro biindane of formula IV:

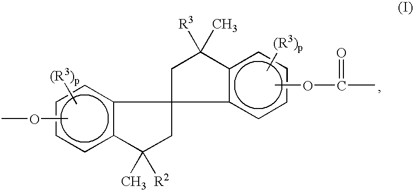

Units derived from SBI and its 5-methyl homologue are preferred, with SBI being most preferred.

Other dihydric phenols which are typically used in the preparation of the polycarbonates are disclosed in U.S. Pat. Nos. 2,999,835, 3,038,365, 3,334,154 and 4,131,575. Branched polycarbonates are also useful, such as those described in U.S. Pat. Nos. 3,635,895 and 4,001,184. Polycarbonate blends include blends of linear polycarbonate and branched polycarbonate.

It is also possible to employ two or more different dihydric phenols or a copolymer of a dihydric phenol with an aliphatic dicarboxylic acids like; dimer acids, dodecane dicarboxylic acid, adipic acid, azelaic acid in the event a carbonate copolymer or interpolymer rather than a homopolymer is desired for use in the preparation of the polycarbonate mixtures of the invention. Most preferred are aliphatic C5 to C12 diacid copolymers.

The preferred polycarbonates are preferably high molecular weight aromatic carbonate polymers have an intrinsic viscosity (as measured in methylene chloride at 25° C.) ranging from about 0.30 to about 1.00 dl/gm. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

In the thermoplastic compositions which contain a cycloaliphatic polyester resin and a polycarbonate resin it is preferable to use a stabilizer or quencher material. Catalyst quenchers are agents which inhibit activity of any catalysts which may be present in the resins. Catalyst quenchers are described in detail in U.S. Pat. No. 5,441,997. It is desirable to select the correct quencher to avoid color formation and loss of clarity to the polyester polycarbonate blend.

A preferred class of stabilizers including quenchers are those which provide a transparent and colorless product. Typically, such stabilizers are used at a level of 0.001-10 weight percent and preferably at a level of from 0.005-2 weight percent. The favored stabilizers include an effective amount of an acidic phosphate salt; an acid, alkyl, aryl or mixed phosphite having at least one acidic hydrogen; a Group IB or Group IIB metal phosphate salt; a phosphorus oxo acid, a metal acid pyrophosphate or a mixture thereof. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. The acidic phosphate salts include sodium dihydrogen phosphate, mono zinc phosphate, potassium hydrogen phosphate, calcium dihydrogen phosphate and the like. The phosphites may be of the formula V:

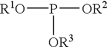

where R1, R2 and R3 are independently selected from the group consisting of hydrogen, alkyl and aryl with the proviso that at least one of R1, R2 and R3 is hydrogen.

The phosphate salts of a Group IB or Group IIB metal include zinc phosphate and the like. The phosphorus oxo acids include phosphorous acid, phosphoric acid, polyphosphoric acid or hypophosphorous acid.

The polyacid pyrophosphates may be of the formula VI:

MzxHyPnO3n+1

wherein M is a metal, x is a number ranging from 1 to 12 and y is a number ranging 1 to 12, n is a number from 2 to 10, z is a number from 1 to 5 and the sum of (xz)+y is equal to n+2. The preferred M is an alkaline or alkaline earth metal.

The most preferred quenchers are oxo acids of phosphorus or acidic organo phosphorus compounds. Inorganic acidic phosphorus compounds may also be used as quenchers, however they may result in haze or loss of clarity. Most preferred quenchers are phosphoric acid, phosphorous acid or their partial esters.

Mold releases such as pentaerythritol tetra esters, especially the stearate esters. Also preferred are carboxylic acid esters of other polyols like glycerol; for example glycerol mono stearate.

In one embodiment, the polycarbonate/cycloaliphatic polyester compositions may include than about 20 percent, and preferably less than about 15 percent of an impact modifier. Typical impact modifiers generally comprise an acrylic or methacrylic grafted polymer of a conjugated diene or an acrylate elastomer, alone, or copolymerized with a vinyl aromatic compound. In general these impact modifiers contain units derived from butadiene or isoprene, alone or in combination with a vinyl aromatic compound, or butyl acrylate, alone or in combination with a vinyl aromatic compound. Other typical impact modifiers include, but are not limited to ethylene vinyl acetate, ethylene ethylacrylate copolymers, SEBS (styrene-ethylene-butylene styrene) and SBS (styrene-butadiene-styrene) block copolymers, EPDM (ethylene propylene diene monomer) and EPR (ethylene propylene rubber) copolymers, etc.

According to a preferred empodiment, transparent and highly ductile compositions can be obtained via the blending of poly(cyclohexane dimethanol cyclohexane dicarboxylate) (PCCD), PC and a transparent impact modifier with a refractive index (RI) between 1.51 and 1.58. The complete miscibility of PC and PCCD allows adjustment of the RI of the PC/PCCD blend to the RI of the impact modifier. There are many impact modifiers which are suitable and some examples are given to illustrate. Examples of such impact modifiers are a clear ABS (acrylonitrile-butadiene-styrene, RI=1.535) and typical PVC modifiers like Blendex 415/336 (ABS material) supplied by GE Plastics or Paraloid BTA 702/736 (MBS material) supplied by Rohm & Haas or Kane Ace B28 / B58 (MBS material) supplied by Kaneka. All these PVC modifiers do have a RI between 1.53 and 1.55. These parts have a unique combination of impact, transparency and chemical resistance.

Additionally, additives such as mold releases, antioxidants lubricants, nucleating agents such as talc and the like, other stabilizers including but not limited to UV stabilizers, such as benzotriazole, supplemental reinforcing fillers, and the like, flame retardants, pigments or combinations thereof may be added to the compositions of the present invention.

Adding visual effect additives like metal or mica flakes in combination with organic dyes which do not result in a significant increase in the brittle nature of the material. A colorant in the form of flakes is present for imparting a desired coloration. Preferably the colorant flakes which ranging in size between 17.5 and 650 microns are used in loadings of 0.01 to 20. 0 weight percent, preferably 0.10 to 15.0 weight percent, more preferably 0.25 to 10.0 weight percent, and most preferably 0.5 to 5.0 weight percent are preferred. The flakes are preferably metal flakes. The term metal flakes is intended to include thin particles including thin film, foil, or platelets which typically have a metallic appearance.[need to refine dimension info] Preferred metal particles are based on metals of Group I-B, III-A, IV, VI-B and VIII of the periodic table. Also, physical mixtures or alloys of these metals may be employed. Also, physical mixtures or alloys of these metals may be employed. Examples of these metals include aluminum, bronze, brass, chromium, copper, gold, iron, molybdenum, nickel, tin, titanium, zinc and the like. For most applications, a “cornflake” type or corrugated irregularly shaped planar flake of aluminum or bronze is preferred, although a “silver dollar” type or a circular planar type of flake may also be utilized. Use of metal particles having two or more average flake sizes, i.e. at least two different average particle sizes, has been found to give much better control of the desired appearance and also been found to allow a greater consistency of achieving the desired appearance.

Aluminum flakes produce a satiny silver luster. In general, smaller particle sizes tend to have greater opacity and hiding power with a grayish effect, while larger flake sizes show greater brightness and reflectivity with increased metallic sparkle. Combination of particle sizes are utilized to balance tinctorial strength and specular effects in addition to providing control of look and consistency.

Glitter is a special type of aluminum pigment produced from foil. The foil, rolled to gauges of less than 0.001 inch, is cut into square, rectangular or hexagonal shapes in sizes from 0.008 to 0.125 inch and typically coated with a transparent epoxy lacquer to halt oxidative dulling of the foil. Glitter, with its large particle sizes, can produce discrete specular highlights.

Gold bronzes are actually brasses—alloys of copper and zinc with a small amount of aluminum to reduce oxidation. The range of gold colors is produced by varying proportions of major alloy components. The green golds contain 70 percent copper, and color becomes redder as the percentage of copper is increased; 90 percent copper produces pale gold; deep golds are made by controlled oxidation of the alloys. Gold bronzes are usually utilized in flake form, with coarser grades giving more brilliance. Copper must be utilized with care, however, as it is susceptible to heat, moisture and corrosives.

Lubricants such as ethylene bis stearamide, butyl stearate, glycerin or mineral oils or the like are sometimes included in the binder formulation, and may or may not be compatible with other blend components.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl4-hydroxy-3-methylphenyl)-propionic acid with monohydric or polyhydric alcohols; vii) esters of beta-(5-tert-butyl-4-hydroxy-3-methylphenyl) propionic acid with mono-or polyhydric alcohols, e.g., with methanol, diethylene glycol, octadecanol, triethylene glycol, 1,6-hexanediol, pentaerythritol, neopentyl glycol, tris(hydroxyethyl) isocyanurate, thiodiethylene glycol, N,N-bis(hydroxyethyl) oxalic acid diamide. Typical, UV absorbers and light stabilizers include i) 2-(2′-hydroxyphenyl)-benzotriazoles, for example, the 5′methyl-,3′5′-di-tert-butyl-,5′-tert-butyl-,5′(1,1,3,3-tetramethylbutyl)-,5-chloro-3′,5′-di-tert-butyl-,5-chloro-3′tert-butyl-5′methyl-,3′sec-butyl-5′tert-butyl-,4′-octoxy,3′,5′-ditert-amyl-3′,5′-bis-(alpha, alpha-dimethylbenzyl)-derivatives; ii) 2.2 2-Hydroxy-benzophenones, for example, the 4-hydroxy-4-methoxy-,4-octoxy,4-decloxy-,4-dodecyloxy-,4-benzyloxy,4,2′,4′-trihydroxy-and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate. Phosphites and phosphonites stabilizers, for example, include triphenyl phosphite, diphenylalkyl phosphites, phenyldialkyl phosphites, tris(nonyl-phenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite tristearyl sorbitol triphosphite, and tetrakis(2,4-di-tert-butylphenyl)4,4′-biphenylene diphosphonite.

The preferred dyes or pigments, if desired, are organic dyes or pigment complexes which are, in themselves, soluble in the resin matrix. These organic dyes and pigments include the following classes and examples: furnace carbon black, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others. It may be necessary to use small quantities of inorganic pigments such as TiO2, iron oxide, cadmium-mercury compounds, cadmium-lithium compounds, etc. to achieve certain colors, but such inorganic pigments are generally not used.

The method of blending the compositions can be carried out by conventional techniques. One convenient method comprises blending the polyester or polycarbonate and other ingredients in powder or granular form, extruding the blend and comminuting into pellets or other suitable shapes. The ingredients are combined in any usual manner, e.g., by dry mixing or by mixing in the melted state in an extruder, on a heated mill or in other mixers. Colorants may be added to the extruder downstream of the feed port.

The flakes are incorporated into the resin composition by uniformly mixing into the desired resin composition. It is important flakes be stable at processing temperatures. Stability is desired at temperatures on the order of about 400, preferably at 500, and even more preferably 550 degrees F. Unstable flakes should be avoided.

The compositions of the present invention includes dyes and stabilizers which are added in effective amounts to impart the desired properties on the compositions of the present invention for the specific application.

The resin comprises less than 5 percent by weight additional ingredients which may be added to contribute to desirable properties previously mentioned of additional, important properties which include good mechanical properties, color stability, oxidation resistance, good flame retardancy, good processability, i.e. short molding cycle times, good flow, and good insulation properties.

One convenient method comprises blending the resins and other ingredients in powder or granular form, extruding the blend and comminuting into pellets or other suitable shapes. The ingredients are combined in any usual manner, e.g., by dry mixing or by mixing in the melted state in an extruder, on a heated mill or in other mixers. An alternative method of blending can comprise preparing a preblend of the polyesters and then adding the other ingredients to the preblend. For example, a preblend of the resins and stabilizer can be fed into the upstream port of an extruder with addition of the other ingredients such as glass fibers in a downstream port of the extruder. In another embodiment, the various compounds can be precompounded, pelletized and then molded. Precompounding can be carried out in conventional equipment. For example, a dry blend of the ingredients can be fed into a single screw extruder, the screw having a long transition section to insure proper melting. Alternatively, a twin screw extrusion machine can be fed with the resins and other additives at the feed port and reinforcements fed downstream. In either case, a generally suitable machine temperature will be from about 450° to about 575° F. The precompounded composition can be extruded and cut or chopped into molding compounds, such as conventional granules, pellets, etc. by standard techniques. The compositions can be molded in any equipment conventionally used for thermoplastic compositions. For example, good results will be obtained in an injection molding machine, with conventional cylinder temperatures, e.g., 500° F., and conventional mold temperatures, e.g., 150° F.

In another embodiment, the various compounds can be precompounded pelletized and then extruded into films. These films can then be used as the decorative film in an IMD article where the film remains with the product for the life of the product.

The multi-layer films can be transparent, or opaque as desired. Transparent products are preferred embodiments of this invention. A variety of laminating techniques can be used. However, heat lamination is preferred. Acrylic adhesives are preferred for use in the present invention.

One of the most efficient and cost-effective ways of decorating a part is to do it during the molding cycle. One way to accomplish this is by inserting a decorated substrate into the cavity of a molding tool and injecting plastic behind it. This process is generally known as in-mold decoration or insert mold decoration (IMD). The decoration for the finished part can either be exposed to the environment (“first surface decoration”) and/or encapsulated between the substrate and the injected material (“second surface decoration”).

Other parameters contribute to the preparation of the second surface decorated parts. First, high temperature, formable inks are preferably used for the graphics. Second surface decoration requires more robust ink systems to provide adequate ink adhesion during the molding process. Moreover, in applications such as light assemblies where light transmission is critical, dye inks should be used rather than pigmented inks so as not to affect light transmission and haze readings. Evaluation of many different inks indicates that many ink systems are not suitable for second surface decorating. Among those inks which are appropriate are the following: Naz-dar 9600, Coates C-37 Series, Coates UVIMD, Marabuwerke IMD Spezialfarbe 3061, Marabuwerke IMC 5001, Nor-cote (UK) IMD Series, Sericol Techmark MTS, Sericol Techmark IMD, Procell Noriphan HTR.

Prototype molds may be constructed from common materials such as plaster, hard woods, fiberglass, syntactic foam and silicone. These materials are relatively easy to work with and allow minor modifications. It is common practice for designers to experiment with IMD to cast a silicone forming mold off an existing injection mold. For example, production forming tools should be constructed of durable materials such as cast or machined aluminum, steel or metal filled epoxy. Conductive molds should be internally heated to a temperature of 250° F.

The formed part will contract in size once it is removed from the mold and allowed to cool. The amount of shrinkage depends on the material selected, but it is predictable and must be accounted for when calculating the mold dimensions. The same is true for the expansion of the mold at operating temperatures. For example, LEXAN® polycarbonate film will typically shrink approximately 0.5-0.9% after forming, depending on the mold. The thermal expansion properties of the mold material at an operating temperature of 250° F. must be subtracted from the film shrinkage number to obtain accurate mold dimensions. In addition, draft angles of 5 to 7 degrees are suggested to facilitate part removal from male molds. Female molds require less draft (1 to 2 degrees).

The basic considerations in gating are part design, flow, end use requirements and location of in-mold graphics. The standard guidelines of traditional gating apply to IMD along with several extra considerations. For example, one gate should be used whenever possible to minimize the potential for wrinkling the film. Gates should be located away from end-use impact as well as to provide flow from thick to thin sections to minimize weld lines. Gates should also be located at right angles to the runner to minimize jetting, splay and gate blush. Large parts requiring multiple gates should include gate positions close enough together to reduce pressure loss. Sequential gating may be used to prevent folding of the film at weld lines. Gate land lengths should be kept as short as possible. An impinging gate may be used to ensure that the incoming flow is directed against the cavity wall or core to prevent jetting. Venting (particularly full perimeter venting) may be accomplished by knock outs, cores and parting lines and should be used whenever possible to avoid trapped gas that can burn and rupture the film. In addition, flow restrictions near gate areas can increase the potential for wash out due to increased shear. If bosses, core shutoffs, etc., are needed near a gate, rounded features or corners should be used to reduce shear. Finally, care should also be taken to ensure that the gating distributes the injection pressure over a large area, thus reducing the shear forces at the gate. Examples of gates that accomplish this include fan gates and submarine gates that enter the part via a rib.

When selecting a resin, it is advantageous that the resin's viscosity be sufficiently low such that the pressure necessary to inject it into the mold may be reduced. In addition, the injection may be profiled so that the viscosity of the injected material maintained at a sufficiently low level in the gate area and may be raised after a suitable skin layer is established near the gate. At lower viscosity, the shear force of the injected material is lower and is therefore less likely to disturb the ink on the second surface of the substrate.

It is also possible to print the graphics on the substrate so that they extend beyond the gating area and into the runner system. In this case, if the ink is disturbed by the flow of the injected material, it will be disturbed in the runner area that will be trimmed off after the part is ejected from the mold.

Of course, runnerless systems or heated gating systems may also be employed. With a runnerless system, the drop diameter must be large enough to sufficiently distribute the pressure or flow into a part, such as a rib, which does. With a heated gating system, the tips of the heated gates be maintained at a temperature sufficiently below the softening temperature of the substrate so as to prevent substrate deformation.

Screen-printing is an example of a suitable technique for producing graphics on the film substrates of the present invention. Screen-printing is essentially a stencil printing process which may now be generated by computer with the aid of various software packages. Its ability to vary and control ink thickness accurately has made it an extremely useful process for the decoration of many different types of plastic substrates.

In screenprinting, a screen or stencil is prepared and bonded to a fine weave fabric which is then tensioned in a rigid frame. Frames may be made of either wood or metal, with metal being preferred. The frame must be dimensionally stable and able to withstand handling during the printing process. Screen fabrics are generally made from metallized polyester, nylon, stainless steel, and most commonly, polyester. The fabric is tightly woven under precise control using dimensionally exact filaments. There are a number of variables that affect ink deposit, including thread diameter, squeegee angle and hardness, emulsion thickness, etc. Higher mesh screens are suggested for formed IMD applications.

The basic screenprinting process involves the use of a flat bed where the substrate is held by vacuum during printing. A frame holder positions the screen and holds it both vertically and horizontally during the printing process. With the screen lowered over the substrate bed and held at the off contact distance by the press, the squeegee carrier moves the blade across the screen at a preset speed, pressure, stroke and angle.

It is important to register artwork during a screenprinting operation. This is normally done by locking the frame into a holder that aligns the frame using pins or holders. The pin alignment method is generally preferred because the artwork can be aligned along with the screen frame. Alignment of the substrate with the print image is done through the use of edge guides, mechanical stops or automatic devices. The first color is aligned by this method and subsequent colors are aligned through the use of targets or gauge marks which are printed along side the artwork.

Once the ink is printed, it must be either dried or cured depending on the ink technology used. If the ink is solvent or water based, then a gas fired or electric dryer can be used to dry the ink. When printing on plastic films, it is important to control the temperature and dwell time in the oven to avoid distorting the film. If a solvent ink is used, it is important to use an oven with good air flow to dissipate the fumes. It is also possible to use an infrared dryer on some ink types, but particular attention must be paid to the temperature control of the system. If the ink is UV curable, many suitable commercial units are available for curing such reactive ink types.

If the final piece is three dimensional, there are two basic techniques for forming 3D IMD parts. For parts having a draw depth greater than ½ inch, thermoforming is suggested. For parts containing detailed alphanumeric graphics or draw depths less than ½ inch, cold forming is preferred. For many in-mold decorating (IMD) applications, screen printed film or film with aesthetic ink or effect pigments is often pre-formed and back-molded with a substrate resin material. Pre-forming is done in typical forming equipment like e.g. Niebling machines. In many cases the used form temperatures are low (60 to 90° C.). Due to these low temperatures, transparent materials like polycarbonate and polycarbonate/PBT blends often show cracking issues when large draw-ratios are applied during the forming step.

IMD can involve two types of film processes. In one process, the film is a permanent fixture of the finished good. In this case, the film can act as the aesthetic effect carrier, and/or as a protective layer for the substrate resin, the ink, or both. Good adhesion is required between the film (normally PC) and the substrate resin. The film is a temporary carrier for the aesthetic effect. In this case the substrate resin is back-molded on the IMD film and the film is subsequently peeled off of the substrate resin, leaving the aesthetic material/design behind on the substrate resin. Good adhesion is not desired between the film (normally PET) and the substrate resin. A common resin used as an JMD substrate is a blend of polycarbonate (PC) with ABS (acrylonitrile-butadiene-styrene), such as Cycoloy produced by GE Plastics. Aesthetic effect Polycarbonate film material can be used in several applications like e.g. Light switches, parts of mobile phones etc. In most cases pre-formed film material will be back-molded with PC or PC/ABS resin material. To overcome mentioned pre-form issues and get additional improved chemical resistance the PC/PCCD blends may be used in above mentioned applications. Screen-printed front parts of remote controls, blood sugar testers, hospital equipment and automotive parts often have to be pre-formed before back-molding. PC/PCCD will have a perfect fit in those applications where improved forming behaviour after screen-printing is required. For some wireless personal electronic applications a film (PC) with ink patterns is back molded with a transparent resin to mold the complete product housing. This is done so that data can be transferred to/from the electronic product to its server through an IR transparent window which is integrated into the structural resin of the product's design. The film is a permanent aesthetic part of the finished product and has formed holes in it so as not to cover the transparent resin underneath for either data transfer or aesthetic purposes. Problems with available transparent material include cracking issues during the forming step due to low temperatures causing high stress level. Distortion of the print on the film during low temperature forming which may be caused by high stress levels typically encountered with high Tg materials like PC and PC/PBT. Other improved chemical resistant materials like PC/PBT are not completely transparent and for this reason only available in a textured version. With PC/PCCD it's possible to make a 100% transparent polish film version. For telecom/personal electronics devices, chemical resistance with low temperature impact are desirable even with films having special effects and high clarity. The chemical resistance of many transparent, amorphous materials is not sufficient towards chemicals like oleic acid and or Coppertone SF 30 sun tanning lotion, which are considered to be important chemicals in qualifying new materials in the telecom/electronics business. In some cases it is preferred to have a translucent material, since some light scattering can contribute to the desired effect.

Transparent blends of Polycarbonate (PC) and poly(cyclohexane dimethanol cyclohexane dicarboxylate) (PCCD) possess lower processing temperatures. Especially in the forming step this is a big advantage. Forming operations include thermoforming, hydro, and Pressure forming. For film, pressure forming like “Niebling”, is may be used. As low temperatures are involved in these pressure forming processes, PCCD specifically shows an advantage over other transparent film materials. Large draw-ratios at low temperatures are possible without cracking issues. Also faster cycle times and lower form temperatures during thermoforming will be possible.

These blends also offer superior chemical resistance and ductility to that of most transparent resin materials. Also PC/PCCD blends show improved UV weathering results over PC as PCCD is not absorbing any UV.

Two types of cycloaliphatic polyesters can be used with BPA-based polycarbonate to give the compositions and articles of this invention. The most preferred polyester molecules are derived from cycloaliphatic diol and cycloaliphatic diacid compounds, specifically polycyclohexane dimethanol cyclohexyl dicarboxylate (PCCD).

For many in-mold decorating (IMD) applications, screen printed film or film with aesthetic ink or effect pigments is often pre-formed and back-molded with a substrate resin material. Pre-forming is done in typical forming equipment like e.g. Niebling machines. In many cases the used form temperatures are low (60 to 90° C.). Due to these low temperatures, transparent materials like polycarbonate and polycarbonate/PBT blends often show cracking issues when large draw-ratios are applied during the forming step. IMD can involve two types of film processes. In one process, the film is a permanent fixture of the finished good. In this case, the film can act as the aesthetic effect carrier, and/or as a protective layer for the substrate resin, the ink, or both. Good adhesion is required between the film (normally PC) and the substrate resin. The film is a temporary carrier for the aesthetic effect. In this case the substrate resin is back-molded on the IMD film and the film is subsequently peeled off of the substrate resin, leaving the aesthetic material/design behind on the substrate resin. Good adhesion is not desired between the film (normally PET) and the substrate resin. A common resin used as an IMD substrate is a blend of polycarbonate (PC) with ABS (acrylonitrile-butadiene-styrene), such as Cycoloy produced by GE Plastics. Aesthetic effect Polycarbonate film material can be used in several applications like e.g. Light switches, parts of mobile phones etc. In most cases pre-formed film material will be back-molded with PC or PC/ ABS resin material. To overcome mentioned pre-form issues and get additional improved chemical resistance the PC/PCCD blends may be used in above mentioned applications. Screen-printed front parts of remote controls, blood sugar testers, hospital equipment and automotive parts often have to be pre-formed before back-molding. PC/PCCD will have a perfect fit in those applications where improved forming behaviour after screen-printing is required. For some wireless personal electronic applications a film (PC) with ink patterns is back molded with a transparent resin to mold the complete product housing. This is done so that data can be transferred to/from the electronic product to its server through an IR transparent window which is integrated into the structural resin of the product's design. The film is a permanent aesthetic part of the finished product and has formed holes in it so as not to cover the transparent resin underneath for either data transfer or aesthetic purposes. Problems with available transparent material include cracking issues during the forming step due to low temperatures causing high stress level. Distortion of the print on the film during low temperature forming which may be caused by high stress levels typically encountered with high Tg materials like PC and PC/PBT.

Other improved chemical resistant materials like PC/PBT are not completely transparent and for this reason only available in a textured version. With PC/PCCD it's possible to make a 100% transparent polish film version. For telecom/personal electronics devices, chemical resistance with low temperature impact are desirable even with films having special effects and high clarity. The chemical resistance of many transparent, amorphous materials is not sufficient towards chemicals like oleic acid and or Coppertone SF 30 sun tanning lotion, which are considered to be important chemicals in qualifying new materials in the telecom/ electronics business. In some cases it is preferred to have a translucent material, since some light scattering can contribute to the desired effect.

Transparent blends of Polycarbonate (PC) and poly(cyclohexane dimethanol cyclohexane dicarboxylate) (PCCD) possess lower processing temperatures. Especially in the forming step this is a big advantage. Forming operations include thermoforming, hydro, and Pressure forming. For film, pressure forming like “Niebling”, is may be used. As low temperatures are involved in these pressure forming processes, PCCD specifically shows an advantage over other transparent film materials. Large draw-ratios at low temperatures are possible without cracking issues. Also faster cycle times and lower form temperatures during thermoforming will be possible.

These blends also offer superior chemical resistance and ductility to that of most transparent resin materials. Also PC/PCCD blends show improved UV weathering results over PC as PCCD is not absorbing any UV.

### EXAMPLE

An extruded sheet and film of thermoplastic materials may be produced by a method which comprises feeding thermoplastic resin into an extruder which heats the resin above its glass transition temperature (Tg), thereby producing a viscous melt of the thermoplastic material. The terms sheet or film are used interchangeably herein, and are used to refer to thermoplastic materials having a final thickness of about 0.005 to 0.030 inches. The viscous melt is passed, under pressure provided by the extruder, through an opening in die, which opening typically has the shape of an elongated rectangle or slot. The viscous melt assumes the shape of the die slot, thereby forming a continuous sheet or film of molten extrudate. The sheet or film of molten extrudate is then passed through a finishing apparatus to form finished sheet or film articles.

A conventional finishing apparatus is a two-roll finishing or polishing stack, comprising an opposing upper roll and lower roll spaced apart by a distance that generally corresponds to the desired thickness of the finished thermoplastic sheet or film. Such rolls are also sometimes referred to as calendering rolls and the gap between them as the nip of the finishing stack. A typical finishing stack comprises opposing upper and lower steel rolls which are approximately 12 to 20 inches in diameter. One roll is covered with an elastomer material, such as rubber. Another roll has a chrome plated surface with a surface roughness of about 0.05 μm. These rolls are generally cooled internally by passing a fluid through the interior of the rolls using known apparatus and methods for cooling. After the finished sheet or film exits from the nip of the finishing stack, it typically enters the second nip of the rollstack. This second nip comprises an opposing roll and roll spaced apart by a distance that generally corresponds to the desired thickness of the finished thermoplastic sheet or film. The film passes through a thickness scanner, through the pull rolls, and is wound onto the winder.

The temperature of the rolls is typically controlled to a temperature that is below Tg of the thermoplastic material that is being processed. In the gap between the rolls, the surfaces of the sheet or film are abruptly vitrified via contact with the calendering rolls. Therefore, upon contact with the rolls, only the interior portion of the film remains in the thermoplastic or molten state. A 4″×6″ laminated film sample is cut and taped at one end and decorated and formed.

A film made is printed with a polyester based ink using a 230 mesh screen. The decorated film is then thermoformed using a “zero gravity” process. This process comprises a sealed thermoformer that allows the application of positive air pressure under the film during preheating and eliminates film sagging. The decorated laminate film is dried before. The film is inserted into the mold of an injection molding machine. Films are a 60/40 PCCD/PC blend, and the films set forth in Table 1 including a film formed entirely of PCCD. The resulting films are optically transparent and between 10-15 mils thick.

The films are in mold decorated with different GE resins, i.e. Cycolac GPM 5500, Cycoloy C6200, Lexan 121 and Lexan 141. No adhesion promoters or treatments were used.

The polyester films, as set forth with various ratios of PC/PCCD, are formed at the following conditions of Table 1 which are in reference to the apparatus previously described. Note that the PC* is a comparative example provided for comparison purposes.

TABLE 1

| | | 70/30 | 50/50 | 50/50 | 50/50 | PC* |
|---|---|---|---|---|---|---|
| Barrel zone 1 | ° C. | 240 | 240 | 240 | 240 | 260 |
| Barrel zone 2 | ° C. | 255 | 250 | 250 | 250 | 270 |
| Barrel zone 3 | ° C. | 255 | 250 | 250 | 250 | 270 |
| Barrel zone 4 | ° C. | 255 | 250 | 250 | 250 | 270 |
| Adaptor | ° C. | 260 | 255 | 255 | 255 | 285 |
| Die adaptor | ° C. | 280 | 270 | 270 | 270 | 295 |
| Die zone 1 | ° C. | 278 | 275 | 275 | 280 | 300 |
| Die zone 2 | ° C. | 280 | 275 | 275 | 280 | 300 |
| Die zone 3 | ° C. | 278 | 275 | 275 | 280 | 300 |
| Screw speed | RPM | 36 | 37 | 85 | 65 | 69.6 |
| Motor load | % | 39 | 37 | 50 | 43 | 65 |
| Melt temp | ° C. | 280 | 275 | 277 | 275 | 301 |
| Melt pressure | BAR | 75 | 65 | 140 | 101 | 140 |
| Roll temp 1 | ° C. | 120 | 100 | 100 | 94 | 140 |
| Roll temp 2 | ° C. | 125 | 105 | 95 | 106 | 145 |
| Roll temp 3 | ° C. | 120 | 100 | 90 | 90 | 136 |
| Line speed | m/min | 2.9 | 2.9 | 4.74 | 4.32 | 3.96 |
| gauge | μm | 540 | 540 | 490 | 460 | 590 |

The polyester film was derived from cycloaliphatic diol and cycloaliphatic diacid compounds and comprised polycyclohexane dimethanol cyclohexyl dicarboxylate (PCCD)

TABLE 2
Forming

| PC/PCCD ratio/% | form temperature/° C. |
|---|---|
| 50/50 | 165 |
| 60/40 | 174 |
| 70/30 | 193 |
| 100* | 220* |

TABLE 3
UV weathering 160 Hours SAEJ1885 Test

| PC/PCCD ratio/% | YI |
|---|---|
| 50/50 | 3.7 |
| 100* | 5.2* |

*Comparative Examples

The results shown in Table 2 illustrate how PC/PCCD materials have a lower forming temperature which is advantageous for in mold decorating film applications. The results shown in Table 3 illustrate how PC/PCCD film materials may be formed significantly faster than a 100% PC film. The faster formation of PC/PCCD films is advantages with inks that may tend to deteriorate at higher temperatures associated with PC.

The claims are:

1. A method of molding comprising forming a decorative substrate into a three-dimensional shape, placing said substrate into a mold, injection molding a resin into the mold cavity space behind the formed substrate, said decorative substrate comprising a substantially transparent cycloaliphatic polyester resin.

2. A method of molding according to claims 2 where said shape and said injection molded resin form a single molded part.

3. A method of claim 2 where the cycloaliphatic polyester consists essentially of cycloaliphatic diacid and cycloaliphatic diol units.

4. A method of claim 2 where said substrate consists essentially of cycloaliphatic polyester which consists essentially of polycyclohexane dimethanol cyclohexane dicarboxylate (PCCD).

5. A method of claim 2 wherein the decorative substrate optionally comprises from about 0 to about 80 percent by weight of a polycarbonate resin.

6. A method of claim 2 wherein the decorative substrate optionally comprises from about 0 to about 40 percent by weight of a polycarbonate resin.

7. A method of claim 2 wherein said polycarbonate resin comprises primarily of the following structural units: bisphenol A, spiro biindane bisphenol, an aryl substituted bisphenol, a cycloaliphatic bisphenol or mixtures thereof.

8. A method of claim 7 wherein said decorative comprises a sheet or a film having a thickness of less than about 12 mm.

9. A method of claim 7 wherein said decorative substrate said decorative comprises a sheet or a film having a thickness from about 100 to about 1000 micron.

10. A method of claim 7 where the polycarbonate is BPA-PC and the cycloaliphatic polyester is PCCD.

11. A method of claim 7 where the blend has % transmittance of greater than or equal to 75%.

12. A method of claim 7 where the blend has a glass transition temperature of from about 90 to 150° C.

13. A method of claim 7 wherein the decorative substrate comprises more than about 70 percent by weight cycloaliphatic polyester.

14. A method of claim 3 wherein said decorative substrate comprises less than up to 20% by weight of and impact modifier.

15. A method of claim 14 wherein said impact modifier is substantially transparent.

16. A method of claim 15 comprising less than about 15 percent transparent impact modifier.

17. A method of claim 16 wherein said transparent impact modifier has a refractive index (RI) between 1.51 and 1.58.

18. A method of claim 17 wherein said impact modifier comprises a acrylonitrile-butadiene-styrene.

19. A method of molding according to claim 18 wherein said molded article comprises a decorative film or substrate and an adjacent injection molded polymeric base, and said method includes the steps of:
a) providing said decorative substrate comprising a cycloaliphatic polyester resin having one or more colors on a surface;
b) trimming the decorated substrate or forming and trimming the decorated substrate into a three-dimensional shape;
c) fitting the decorated substrate into a mold having a surface which matches the three-dimensional shape of the substrate; and
d) injecting a base resin into the mold cavity behind the printed substrate to produce a one-piece, permanently bonded three-dimensional product.

20. A method of forming a decorative article comprising forming a base adjacent a substrate having a decorative area and transferring a portion of said decorative area to said base, said substrate comprises a substantially transparent cycloaliphatic polyester resin.

21. A method of forming a decorative article according to claim 20 wherein said base is injected against said substrate.

22. A method of forming a decorative article according to claim 21 wherein said substrate is removed from said base.

23. A method of forming a decorative article according to claim 22 wherein said substrate includes a decorative surface and at least a portion of said decorative surface is transferred to said base.

24. A method of forming a decorative article according to claim 23 wherein said transfer of said decorative surface is during said forming.

25. A method of forming a decorative article according to claim 24 wherein said substrate comprises a cycloaliphatic polyester resin.

26. A method of forming a decorative article according to claim 25 wherein the cycloaliphatic polyester is comprised of cycloaliphatic diacid and cycloaliphatic diol units.

27. A method of forming a decorative article according to claim 26 wherein the cycloaliphatic polyester is polycyclohexane dimethanol cyclohexane dicarboxylate (PCCD).

28. A method of forming a decorative article according to claim 26 wherein the injection molded polymeric base comprises a polycarbonate resin.
